(19) United States
(12) Patent Application Publication
(10) Pub. No.: US 2017/0014987 A1
(43) Pub. Date: Jan. 19, 2017

(54) Sawhorse and Brace Therefor

(71) Applicant: Richard W. King, Xenia, OH (US)

(72) Inventor: Richard W. King, Xenia, OH (US)

(21) Appl. No.: 14/799,115

(22) Filed: Jul. 14, 2015

(51) Int. Cl. B25H 1/06

(52) U.S. Cl. CPC B25H 1/06

(57) ABSTRACT

A sawhorse brace for interconnecting opposing facing pairs of legs of a sawhorse with an optional feature for adding strength with a center horizontal support, wherein the brace has a trapezoid shape with side flanges, upper flange for receiving the legs in a predetermined manner.

This application claims the benefit of earlier filed provisional application 62/070,937 filed Sep. 11, 2014.

### FIELD OF INVENTION

This invention relates to structural support in sawhorses. More particularly, the invention relates to a sawhorse and brace for use in the sawhorse together with suitable lumber, such as two-by-fours with predetermined length.

### BACKGROUND OF THE INVENTION

Sawhorses and sawhorse brackets and braces have long existed in many various configurations. A common bracket comprises a pair of facing spaced side walls, a pair of spaced upwardly convergent end walls extending between the side walls for conforming reception there within of a pair of downwardly diverging legs. One such bracket includes side walls with aligned through openings for passage therethrough of a cross member between the upper ends the legs.

While these prior braces provide a quick way to form a sawhorse, the sawhorse is not very stable without some additional lower bracing. Further, some prior sawhorse constructions have noted that the horizontal or sawhorse cross members (2×4) as a work support can be in position to obstruct many saw cuts. This required rearrangement of the work piece and other inconvenient manipulations. Thus, brackets were modified to accommodate this and raised the cross member above the bracket.

While certain prior existing brackets and braces attempted to overcome these problems, there remains a need for improvement in the art which this invention satisfies.

### SUMMARY OF THE INVENTION

Safety and saving time on the construction site are objectives of the invention. Not having reliable and sturdy sawhorses on the work site create inefficient and unsafe particularly when handling power equipment and heavy materials.

It is an important object to provide a sawhorse brace which is easy to install, use and provides a sturdier sawhorse of the type described above which uses readily available 2×4 (actual size 1½″×3½″) lumber.

It is an important object to provide a sawhorse brace which enables formation of a sawhorse such that a work piece can be supported and cut without the inconvenience of having to move the work piece to adjust the positioning and secure during the cutting operation.

It is an important object to provide a sawhorse brace which compliments the usage of metal sawhorse brackets that are widely available in retail lumber and hardware stores and also may be used on sawhorses which are constructed without metal brackets.

It is an important object to provide a sawhorse brace which is extremely simple in construction being just one piece only without moving parts for economy of cost and enabling mass production little material waste.

It is an important object to provide a sawhorse brace which has and projects the appearance to have strength designed with pressed ribs or grooves to endure handling and usage experienced on a construction site.

It is an important object to provide a sawhorse brace which is long lasting after repeated use and when removed it is reusable on another sawhorse for a durable and long useful life.

It is an important object to layout the holes used to attach this invention to sawhorses so that the screw holes are positioned to not interfere with each other and not weaken the strength of the sawhorse 2×4 boards.

It is an important object to design this invention that shall be easily paired and packaged for retail sales while possessing a means for shelving or mounted displaying on extended rods.

It is an important object to provide a sawhorse brace made of strong metal which is protected with environmentally safe coatings to minimize or eliminate the possibility of rust.

It is an important object to provide a sawhorse brace which the owner may use inexpensive and readily obtainable 1¼″ drywall or other screws (or nailing may be chosen as an alternative) for assembly wherein raised surfaces having holes provide for securing and more easily removal thereof.

It is yet another object of the present invention to provide the “leveling” benefit so like sawhorses may also be useful for other purposes than carpentry such as inexpensive sturdy banquet table legs or safer low-level scaffolding, as examples.

It is an important object of the present invention to provide a sawhorse brace having all the advantageous characteristics mentioned in the preceding paragraphs and possibly others.

Accordingly, one embodiment of the instant invention is directed to a sawhorse brace for interconnecting opposing facing pairs of legs of a sawhorse (2×4 legs), the sawhorse further including a first horizontal support (such as a 2×4 cross member which can be optional if a second horizontal support as later described is used) interconnecting upper ends of the legs. The legs are oriented at an angle such that upper ends of each of facing legs terminate adjacent to one another while lower ends are displaced from each other to form a generally inverted V-shape configuration. The brace has a plate member having an inner face and outer face and is of a generally trapezoid form having a longer base edge, a shorter upper edge, two side edges interconnecting the base edge and the upper edge.

Each of the side edge has a side flange extending inwardly and normal thereto wherein surface portions of the inner face and the side flanges serve as the leg receiving surfaces. Within each of the leg receiving surfaces are formed a plurality of openings, each to receive a connector (screws are preferred as opposed to nails) therethrough for connecting the legs once the upper ends of the legs are connecting adjacent one another. Connectors are inserted through the openings to secure the legs in place. The base edge has a base flange extending inwardly and normal thereto wherein surface portions of the inner face and the base flange serve as a secondary horizontal support receiving surface (such as a 2×4 cross member). Within the secondary horizontal support receiving surface is formed a plurality of openings, each opening to receive a connector (screw or nail) therethrough for connecting ends of the horizontal support. Thus, the base flange is sufficiently spaced below the first horizontal support to permit insertion of the secondary horizontal support. An existing embodiment includes the use of an end bracket capable to receive and connect to the upper ends of the legs and receive a portion of the first horizontal support such that another portion of the first horizontal support is in a raised manner above the end bracket.

The invention provides multi-featured benefits of leveling each saw horse for use with other like formed sawhorses as well as stabilizing sawhorses. The invention accordingly consists in the features of construction, combinations of elements, and arrangements of parts, which will be exemplified in the construction hereinafter described, and of which the scope will be indicated by the appended claims. Other objects of the present invention will become apparent upon reading the following specification and referring to the accompanying drawings, which form a material part of this disclosure.

### BRIEF DESCRIPTION OF THE DRAWINGS

FIG. 1 is a perspective view of an embodiment of the invention with metal bracket;

FIG. 2 is a perspective view of another embodiment of the invention without metal bracket;

FIG. 3 is a top preformed view of the invention;

FIG. 4 is a bottom preformed view of the invention;

FIG. 5 is a front (outside) preformed view of the invention;

FIG. 6 is a back (inside) preformed view of the invention;

FIG. 7 is a right side preformed elevational view of the invention;

FIG. 8 is a left side preformed elevational view of the invention;

FIG. 9 is an embodiment showing an exemplary dimensionally sized embodiment of the invention;

FIG. 10 is a top view of the invention;

FIG. 11 is a bottom view of the invention;

FIG. 12 is a front (outside) view of the invention;

FIG. 13 is a back (inside) view of the invention;

FIG. 14 is a right side elevational view of the invention;

FIG. 15 is a left side elevational view of the invention;

FIG. 16 is a front view showing a retail packaging of two braces mounted on optional retail display rod of the invention;

FIG. 17 is a back view showing a retail packaging of two braces mounted on optional retail display rod of the invention;

FIG. 18 is a top view showing a retail packaging of two braces mounted on optional retail display rod of the invention;

FIG. 19 is a bottom view showing a retail packaging of two braces mounted on optional retail display rod of the invention;

FIG. 20 is a left view showing a retail packaging of two braces mounted on optional retail display rod of the invention;

FIG. 21 is a right view showing a retail packaging of two braces mounted on optional retail display rod of the invention;

FIG. 22 shows one attachment configuration employing screws; and

FIG. 23 is a production layout on sheet metal of the invention.

### DETAILED DESCRIPTION OF THE PREFERRED EMBODIMENTS

Referring now to the drawings, a sawhorse of the instant invention is generally designated by the numerals 10 and 10′. A pair of like formed braces 12 is provided for interconnecting opposing facing pairs of legs 14 of a sawhorse 10.

The legs 14 can be formed by using 2×4 stock material. The sawhorse 10 includes a first horizontal support 16 which can also be made from 2×4 stock material. The first horizontal support 16 interconnects upper ends 18 of the legs 14. The legs 14 are oriented at an angle such that upper ends 18 of each of facing legs 14 terminate adjacent to one another while lower ends 20 are displaced from each other to form a generally inverted V-shape configuration. The upper ends 18 of the sawhorse 2×4 form a tight triangle after positioning the braces 12. In this way connector screws can then enter at an angle therethrough.

All braces are produced with round ⅜″ holes 51 centered at the top under the ¼″ top flange. The hole 51 positioned on the brace 12 remains open or unobstructed when paired for retail merchandising. The hole 51 may be used for mounting the invention on a rod for retail display or for convenient visible storage in a shop environment.

Each brace 12 has a plate member 22 having an inner face 24 and outer face 26 and is of a generally trapezoid form having a longer base edge 28, a shorter upper edge 30, two side edges 32 interconnecting the base edge 28 and the upper edge 30. The braces 12 can be formed from 4¼″×11 1/16″” galvanized sheet metal that is 1/16-⅛″ thick. The braces 12 can be stamped or otherwise formed, for example, with a 6½″ wide upper edge 30 to 8⅜″ wide bottom base edge 28 and 4⅛″ side edges 32. The 90-degree angle of the end flanges require the overall piece of the pre-pressed metal to be 4¼″ wide. When the invention is formed, it may be positioned upright at a 90-degree angle when it is laying on a flat surface.

Each edge 32 has a side flange 34 extending inwardly and normal thereto wherein surface portions 36 and 38, respectively, of the inner face 24 and the side flanges 34 form the leg receiving surfaces 40. The flanges 34 extend approximately 1½″ inward from inner face 24.

Within each of the leg receiving surfaces 40 are formed a plurality of openings 42, each to receive a connector 44 (which can be a screw or nail, for example) therethrough for connecting the legs 14 once the upper ends 18 of the legs 14 are connecting adjacent one another. Connectors 44 are inserted through the openings 42 to secure the legs 14 in place. This invention may or may not includes raised surfaces defining the openings 42.

The upper edge 30 has an inner flange 46 extending inwardly and normal thereto which runs part of a length of the upper edge 30 terminating a predetermined distance form the side edges 32. Inner flange 46 extends about ½″ from front to outer face 26 to inner face 24 at about 90 degrees to secure the a secondary horizontal support 54 and is 4⅜″ with ⅛″ separations from the 2×4 legs 14. The predetermined distance mentioned above provide a space configuration for receiving the legs 14 there through at a predetermined angle and to confine the legs 14 between the side flanges 34 and flange 46. The base edge 28 can have a base flange (not shown) extending inwardly and normal thereto which can run part of a length of the base edge 28 terminating a predetermined distance form the side edges 32. A gap distance can be provided from the base edge 28 and a second horizontal support 54. Such additional top-to-bottom width accommodates positioning various boards which are not the traditional 2×4 or 1½″×3½″ size.

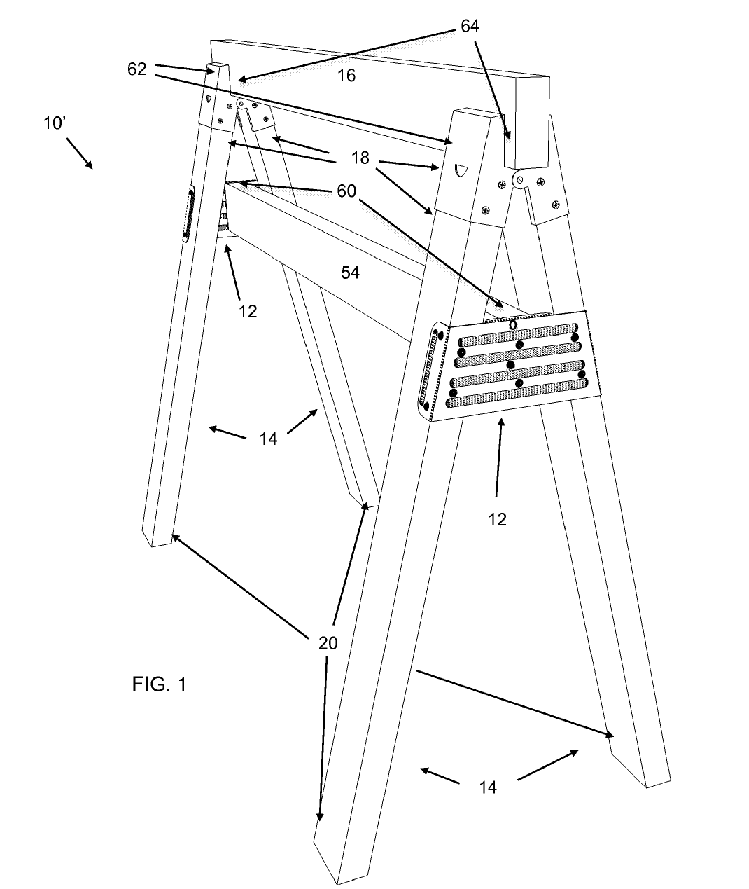

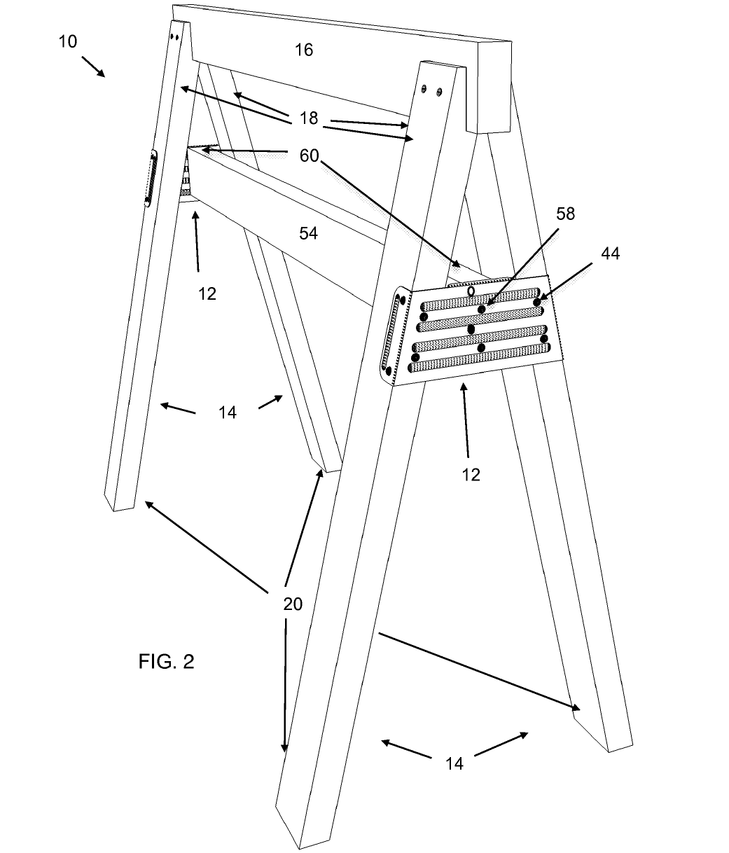

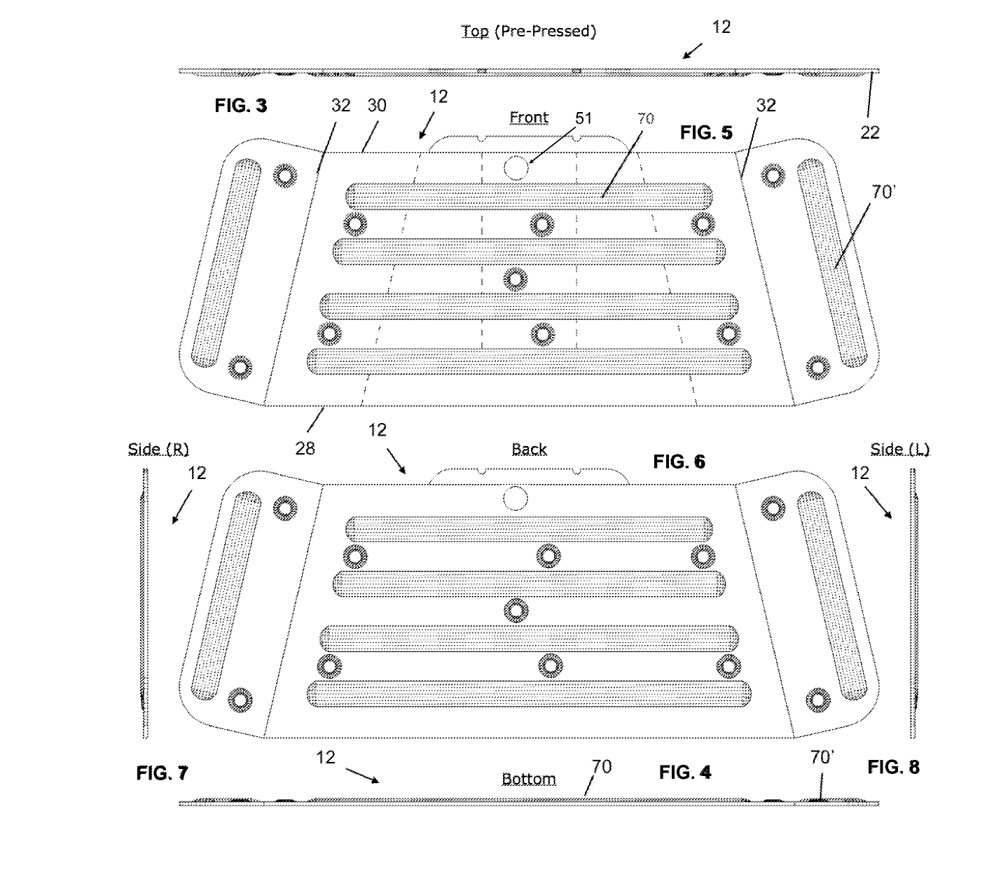

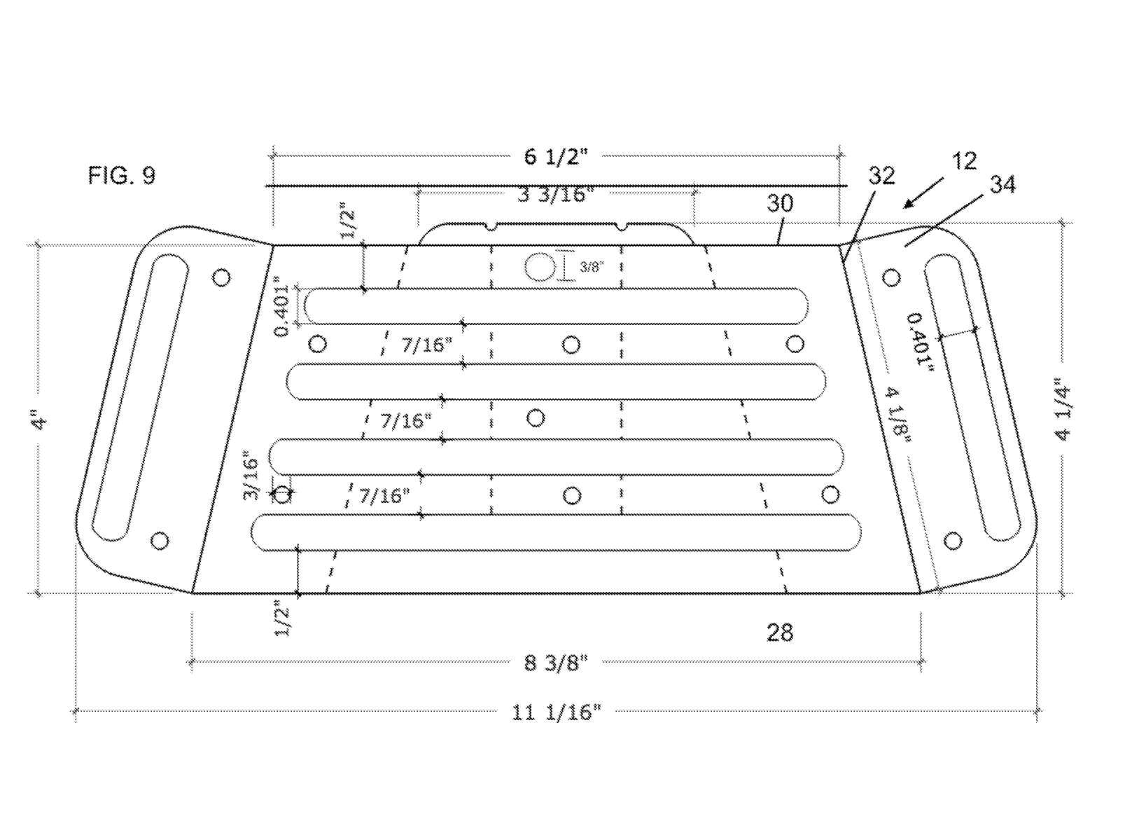

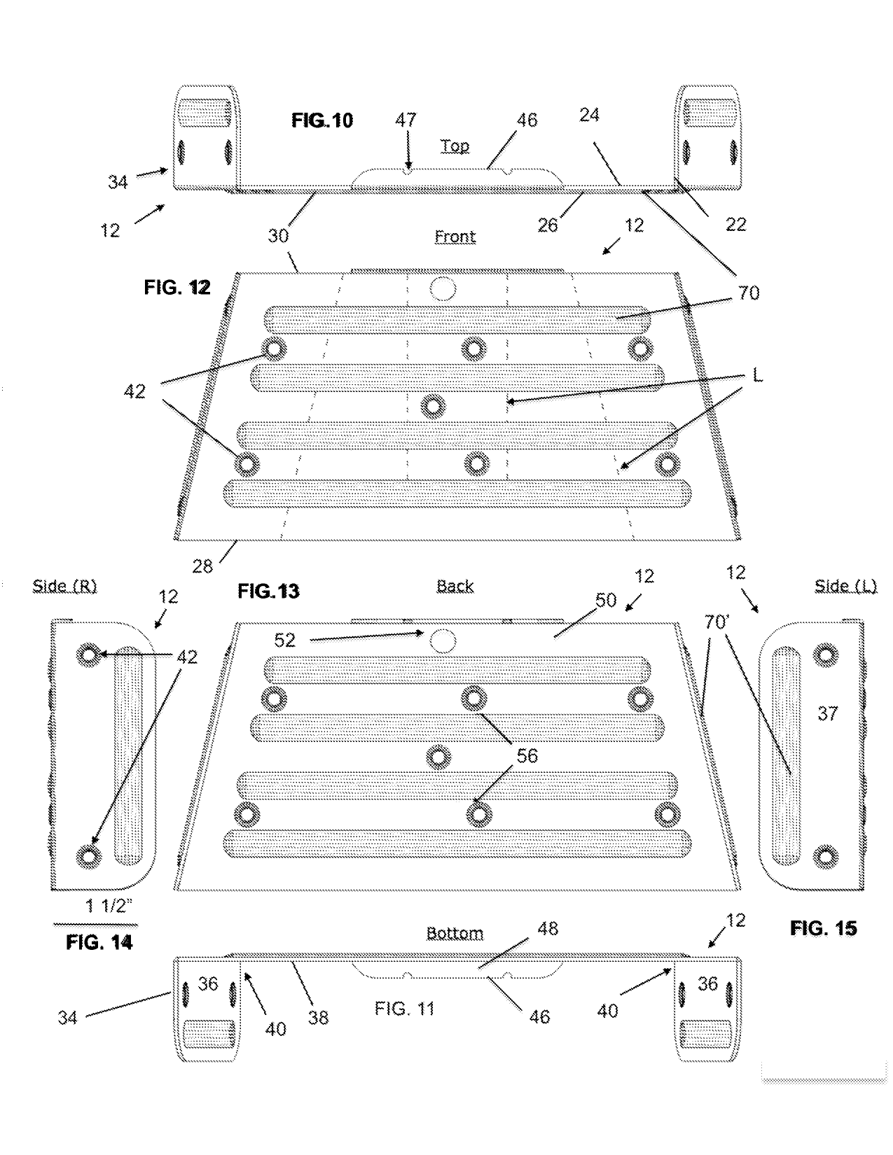

Surface portions 48 and 50, respectively, of the inner face 24 and the inner flange 46 serve as a secondary horizontal support receiving surface 52 for the secondary horizontal support 54 (e.g., a 2×4 cross member). Within the secondary horizontal support receiving surface 52 is formed a plurality of openings 56. Each opening 56 receives a connector 58 (e.g., screw or nail) therethrough for connecting ends 60 of the horizontal support 54. Thus, the inner flange 46 is sufficiently spaced below the first horizontal support 16 to permit insertion of the secondary horizontal support member 54. One embodiment as seen in FIG. 1 includes the use of an end bracket 62 to receive and connect to the upper ends 18 of the legs 14 and receive a portion 64 of the first horizontal support 16 such that another portion 66 of the first horizontal support 16 is in a raised manner above the end bracket 62.

There are two notches 47 or centering “V” marks on the outer edge of the flange that are 1½″ apart to guide installing the second horizontal support 54. Two additional notches or centering of V marks will be added to accommodate actual 2″ wide boards common outside the USA. Each brace 12 further includes one or more strengthening ribs 70 extending transversely across said plate member 22. In the embodiment shown, the ribs 70 run horizontally with convex side extending from face 26, and ribs 70′ run lengthwise across flanges 34 with convex side extending from face 37. It is conceived that other configurations can be employed. Rib sizes can be 0.276″ width×0.109 height, 0.401″ width×0.174 height, or 0.446″ width×0.221 height or may vary based on design and source. Rib width influences the design so the top-to-bottom measurement of the brace 12 increases/decreases as a function of this. The wider the ribs, the better for endurance and customer perception of strength. There can be four parallel ribs 70 with lengths extending between the 2×4 legs and ending about ½″ from the side flanges 34. Additional ribs may be incorporated across the inner flange 46.

The 4″ height of the invention front will not decrease so as to accommodate worldwide use. The US 2×4 (actual 1½″×3½″) in other countries could be an actual 2″×4″ measurement. Thus, the 4″ height will accommodate the ends of the optional horizontal support board if it is a US 2×4 or an overseas actual 2×4 stud lumber.

By so providing, the invention structurally joins the legs 14. The brace 12 and bracket 62 can be formed of metal or polymer with sufficient strength to achieve the intended and described application. The flanges 34 that are flat about ¼″ and rounded corners to prevent skin cuts. Side flanges 34 extend approximately 1½″ from edge 32 and generally at 90 degrees from outer face 26 and have a length of about 4″. It is understood, the width of the flanges 34 may be adjusted slightly to accommodate the layout as long as they both stay exact and with the overall initial plate stock size e.g., is 4¼″×11 1/16″. Note: This 4¼″×11 1/16″ may vary by increasing to accommodate this basic shape due to manufacturing limitations. With an upright 90-degree angle, the flanges 34 provide a surface to nest on and should show prominently when displayed upright on the retail shelf.

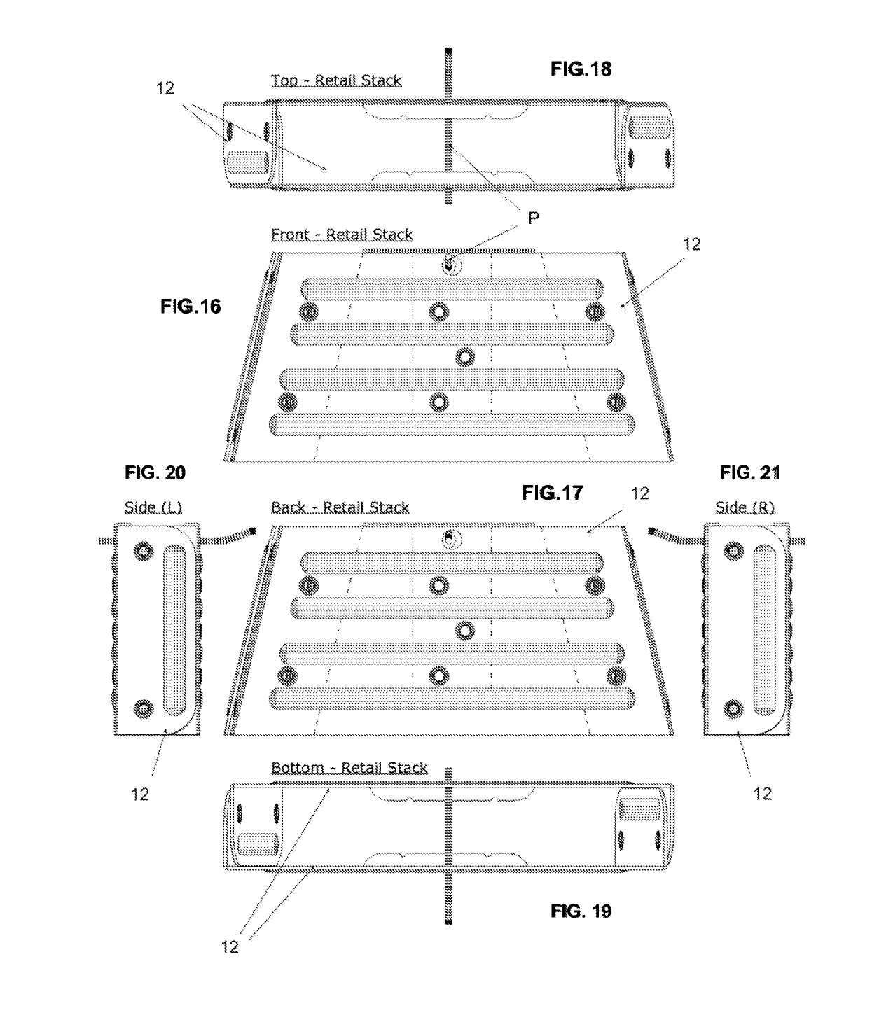

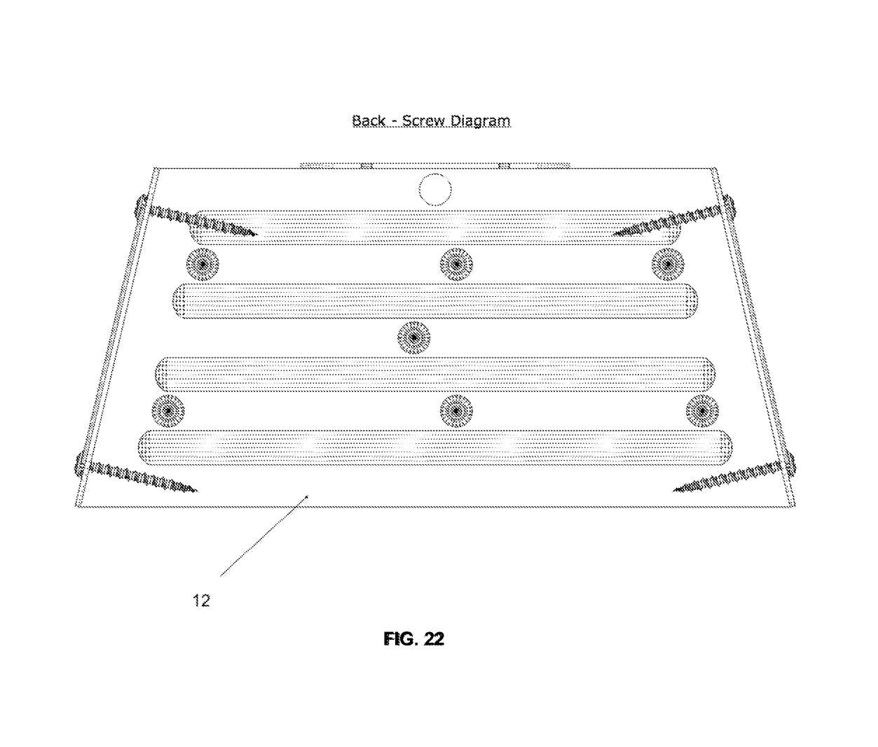

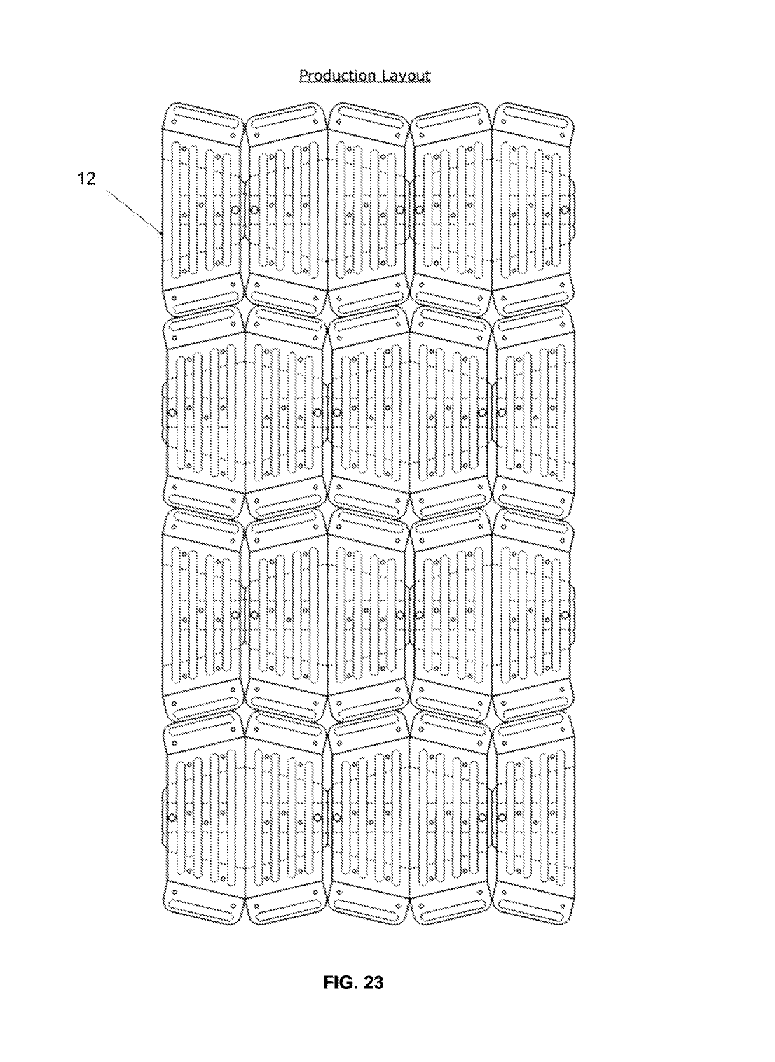

FIGS. 16-21 show a retail configuration with the braces 12 facing each other. A retail pin P extends through the holes 51. The holes 51 provide for efficient handling and retail packaging.

FIG. 22 shows one attachment configuration. This diagram demonstrates how the screws do no interfere with each other and are positioned to not weaken the wood parts of the sawhorse 10.

It is conceivable a bottom flange 8⅜″ long can be provided and bent to the inside for adding strength. The corners are rounded to avoid interference with installation and safety from causing skin cuts. The 3/16″ connector holes 42 need not be raised, though 3/16″ holes inside raised openings extending outward from face 26 accommodates recycling the invention after more easily pulling out nails. Screws are recommended for the brace 12 since nails loosen and the sawhorse sturdiness is in jeopardy. Screws do not require raised openings to achieve the same results.

The 3/16″ connector holes 42 and 56 across the brace 12 can be of a suitable number, such as eleven or more. The two notched sections 47 across the inner flange 46 are designed to assist with mounting the optional horizontal support board whereby the notches 47 define an area within which to center the board. The support board placement is guided so that it is positioned tightly at the top under the extended flange centered when placed between the two notches before attached by screws.

The dashed lines L indicate location of legs and supports to which the invention fits positioned around the same to strengthen and stabilize. The center location of the 2×4 second horizontal support 54 also stabilizes and minimizes the wobbliness of the sawhorse 10. The design accommodates without interference raising the second horizontal support 54 so it is secured tightly against the 90-degree inner flange 46.

The invention is not limited to the specific details of construction disclosed herein, but is capable of other modifications, improvements and derivations to those skilled in the art without departing from the spirit and scope of the appended claim. Accordingly, such claims should be afforded the broader scope of protection as permitted. Having thus described the invention, what is claimed as new and desired to be secured by Letters Patent is:

1. A sawhorse brace for interconnecting opposing facing pairs of legs of a sawhorse, the sawhorse further including a first horizontal support interconnecting upper ends of the legs, the legs oriented at an angle such that upper ends of each of facing legs terminate adjacent one another while lower ends are displaced from each other to form a generally inverted V-shape configuration, the brace comprising:
a plate member having an inner face and outer face of a generally trapezoid form having a longer base edge, a shorter upper edge, two side edges interconnecting said base edge and said upper edge;
a pair of side flanges, each side flange extending from one of said side edges inwardly and normal to said inner face wherein surface portions of said inner face and said side flanges serve as leg receiving surfaces, and within each said leg receiving surface is formed one or more opening to receive a connector therethrough for connecting said legs upon said upper ends of said legs connecting adjacent one another; and
an inner flange extending from said upper edge inwardly and normal to said inner face wherein surface portions of said inner face and said inner flange serve as a secondary horizontal support receiving surface and within said secondary horizontal support receiving surface is formed one or more opening, each said opening to receive a connector therethrough for connecting ends of the secondary horizontal support, said inner flange extends part of a length of said upper edge terminating a predetermined distance form said side edges to provide a space configuration for receiving said legs at a predetermined angle and to confine said legs between said side flanges and said upper flange and wherein said inner flange is sufficiently spaced below the first horizontal support to permit insertion of the secondary horizontal support member.

2. The sawhorse brace of claim 1, which further includes an end bracket to receive and connect to said upper ends of said legs and receive a portion of the first horizontal support such that another portion of the first horizontal support member is in a raised manner above said end bracket.

3. The sawhorse brace of claim 1, which further includes one or more strengthening ribs extending transversely across said brace.

4. The sawhorse brace of claim 1, wherein said inner flange includes notches to define an area within which to center the second horizontal support.

5. A sawhorse, which includes:
a brace for interconnecting opposing facing pairs of legs of a sawhorse, said sawhorse further including a first horizontal support interconnecting upper ends of said legs, said legs oriented at an angle such that upper ends of each of facing legs terminate adjacent one another while lower ends are displaced from each other to form a generally inverted V-shape configuration, said brace including a plate member having an inner face and outer face of a generally trapezoid form having a longer base edge, a shorter upper edge, two side edges interconnecting said base edge and said upper edge; a pair of side flanges, each side flange extending from one of said side edges inwardly and normal to said inner face wherein surface portions of said inner face and said side flanges serve as leg receiving surfaces, and within each said leg receiving surface is formed one or more opening to receive a connector therethrough for connecting said legs upon said upper ends of said legs connecting adjacent one another; and an inner flange extending from said upper edge inwardly and normal to said inner face wherein surface portions of said inner face and said inner flange serve as a secondary horizontal support receiving surface and within said secondary horizontal support receiving surface is formed one or more opening, each said opening to receive a connector therethrough for connecting ends of the secondary horizontal support, said inner flange extends part of a length of said upper edge terminating a predetermined distance form said side edges to provide a space configuration for receiving said legs at a predetermined angle and to confine said legs between said side flanges and said upper flange and wherein said inner flange is sufficiently spaced below the first horizontal support to permit insertion of the secondary horizontal support member.

6. The sawhorse of claim 5, which further includes an end bracket to receive and connect to said upper ends of said legs and receive a portion of the first horizontal support such that another portion of the first horizontal support member is in a raised manner above said end bracket.

7. The sawhorse of claim 5, which further includes one or more strengthening ribs extending transversely across said brace.

8. The sawhorse of claim 5, wherein said inner flange includes notches to define an area within which to center the second horizontal support.
